(19) United States
(12) Patent Application Publication
(10) Pub. No.: US 2014/0193304 A1
(43) Pub. Date: Jul. 10, 2014

(54) DEVICE FOR THE GENERATION OF HYDROGEN, APPARATUSES THAT CONTAIN THE DEVICE, AND THEIR USE

(71) Applicants: Giulio Cenci, Ferrara (IT); Francesco Vizza, Firenze (IT); Jonathan Filippi, IT (IT); Andrea Marchionni, Agliana (IT); Claudio Blanchini, Florence (IT)

(72) Inventors: Giulio Cenci, Ferrara (IT); Francesco Vizza, Firenze (IT); Jonathan Filippi, IT (IT); Andrea Marchionni, Agliana (IT); Claudio Blanchini, Florence (IT)

(73) Assignee: WORGAS BRUCIATORI S.R.L., Formigine (IT)

(21) Appl. No.: 14/237,744

(22) PCT Filed: Aug. 10, 2011
(86) PCT No.: PCT/IB2011/053567

§ 371 Date: Feb. 7, 2014

(51) Int. Cl. B01J 19/08

(52) U.S. Cl. CPC B01J 19/087
USPC 422/119

(57) ABSTRACT

It is described a device for the production of hydrogen gas by a reactor where aqueous solutions of metal borohydrides are hydrolyzed on catalysts based on ferromagnetic metals. Apparatuses containing said device are also described.

### FIELD OF THE INVENTION

The present invention refers to the field of the devices for the production of hydrogen and of the apparatuses that utilize such devices.

### STATE OF THE ART

The use of metal borohydrides, in particular of sodium borohydride (NaBH₄, sodium tetrahydroborate) for the production of hydrogen gas by aqueous hydrolysis is a well-known process which has been widely investigated. A recent scientific article describes exhaustively the state of the art of the catalyzed generation of hydrogen from aqueous solutions of sodium borohydride, of the catalysts employed and of the uses of the hydrogen gas produced U. B. Demirci et al. Fuel Cells 2010, 10 (No. 3), 335). In addition to hydrogen gas, the hydrolysis reaction (1) yields sodium metaborate (NaBO₂), which is a recyclable product with many industrial applications.

NaBH_{4(aq)}+2H₂O→NaBO_{2(aq)}+4H₂↑+heat(300 kJ) (1)

Reaction (1) is a spontaneous and exothermic process that, for practical uses, has to be accelerated by means of suitable catalysts, generally based on finely dispersed transition metals. The catalysts of reaction (1) include noble metal salts (Pt, Rh, Ir, Ru), non-noble metal salts (Mn, Fe, Co, Ni, Cu), metal borides of Co or Ni, metal in the 0 oxidation state either as nano- or micro-structured powders or supported on metal oxides or porous carbons. A perusal of the recent literature (U. B. Demirci et al. Fuel Cells 2010, 10 (No. 3), 335) shows how cobalt boride (CoB), cobalt-cobalt boride (Co—CoB) and nickel-cobalt boride (Ni—CoB) combine an excellent catalytic activity, up to 11 L H₂ min⁻¹ g⁻¹ (H. B. Dai et al. J. Power Sources 2007, 177, 17; Wu et al. Mat. Letters 2005, 59, 1748) with a low cost and the possibility of being separated from the reaction mixture by magnetic attraction.

As shown in reaction (1), the hydrolysis of one mole of NaBH4 yields theoretically four moles of hydrogen and consumes two moles of water which are responsible for the production of two moles of hydrogen. It is therefore correct to state that the hydrogen of reaction (1) is generated by the NaBH₄—H₂O system. In real conditions, reaction (1) consumes more than two moles of water per mole of NaBH₄ due to the formation of a hydrated salt of sodium metaborate whose solubility (28 g in 100 g of H₂O at 25° C.) is lower than that of NaBH₄ (55 g in 100 g of H₂O). Accordingly, to avoid that NaBO₂, precipitating in the solution, may de-activate the catalyst of reaction (1), with consequent reduction of the hydrogen production, it is appropriate to use an initial NaBH4 concentration lower than 16 g in 100 g of water. For practical applications of the NaBH₄—H₂O system to generate hydrogen in a controlled manner, one has to take into account also the stability of the NaBH₄ solutions with time given the thermodynamic spontaneity of reaction (1). To this purpose are commonly employed alkali metal hydroxides, generally sodium or potassium hydroxide (NaOH o KOH). Indeed, the NaBH4 solutions are more stable in alkaline environment with a half-life time depending on the pH value and temperature (Eq. 2) (V. G. Minkina et al. Russ. J. Appl. Chem. 2008, 81, 380).

log(t_{1/2})=pH−(0.034T−1.92) where T=K (2)

Recent studies (B. H. Liu et al. Thermochim. Acta 2008, 471, 103) have demonstrated that an optimum stabilization of the NaBH₄—H₂O—NaOH system is achieved dissolving 150 g of NaBH₄ (3.9 moles) and 100 g of NaOH (ca. 2.5 moles) in ca. 750 mL of water. In the light of what said above, the Gravimetric Hydrogen Storage Capacity (GHSC) of aqueous solutions of NaBH₄ cannot be much higher than 3 wt %, a value which is largely inferior to what recommended by the U.S. Department of Energy (DOE) for the use of NaBH₄ as material for the on-board hydrogen generation for automotive applications. Such a GHSC value is, however, acceptable to feed power generators based on fuel cell stacks up to some hundred watts. Recently, it has been announced the commercialization of portable power generators fuelled with hydrogen generated by hydrolysis of aqueous solutions of NaBH₄ and capable of supplying powers up to 50 W (Hydropak by Horizon, www.horizonfuelcell.com).

It is evident that the generation of the hydrogen gas required to feed a fuel cell stack must take place in a reactor where the NaBH₄—H₂O—NaOH system reacts on a suitable catalyst. Several types of such reactors, either static or dynamic, are known. In some static devices, the catalyst is introduced into the vessel containing the NaBH₄ solution as powders, pellets or it is supported on inert porous materials such as honeycomb monolyths (Y. Kojima et al. J. Power Sources 2004, 33, 1845; http://www.fractalcarbon.com). The static systems exhibit generally low efficiency due to various reasons, among which there is the difficulty of catalyst separation from the exhausts, the catalyst leaching from the support, the de-activation of the catalyst occasioned by the precipitation of sodium metaborate and, finally, mass transport phenomena. Higher efficiency seems to be shown by the dynamic systems based on the flow of the NaBH₄—NaOH solution inside a tubular reactor containing an appropriate catalyst. In an attempt of separating the catalyst from the NaBH₄ solution and avoiding the contamination of the exhausts by the catalyst have been used filters (U.S. Pat. No. 6,534,033). Apparently, this technology requires appropriate dimensions of the catalyst with potential activity losses. In some scientific papers (S. C. Amendola et al. Int. J. Hydrogen Energy 2000, 25, 969; S. C. Amendola et al. J. Power Sources 2000, 85, 186) and patents (US 2003/0037487, US 2005/0268555, U.S. Pat. No. 6,932,847, WO 03/004145) is described the use of a peristaltic pump that forces the NaBH₄ solution to pass through a reactor containing a Ru-based catalyst supported on ion-exchange resins. Such devices are not free of catalyst degradation due to the high pH values of the NaBH₄—H₂O—NaOH system as well as to catalyst physical leaching occasioned by the turbulence generated by the hydrogen bubbles and by the locally high pressure of the hydrogen gas that forms not only on the catalytic layer, comprising nano- and micro particles, but also inside the layer itself. The reactor described in the papers and patents reported above produces a maximum hydrogen flow of ca. 200 mL min⁻¹ gcatalys⁻¹ and is part of the Millennium Cell and Horizon Fuel Cell technology applied to the Hydropak generators (www.millenniumcell.com; www.horizonfuelcell.com) with a nominal maximum power of 50 W.

A further method to increase the physical stability of the catalyst during the hydrogen generation has been realized with the use of permanent magnets externally positioned to a tube inside which a ferromagnetic catalyst, preferably based on Fe—Pt—Rh, is immobilized by action of the external magnetic field, during the flow of an alkaline solution of NaBH₄ (EP 1496014A1; A. Pozio et al. Int. J. Hydrogen Energy 2008, 33, 51; A. Pozio et al. Int. J. Hydrogen Energy 2009, 34, 4555). Such a technology has allowed the ERRE DUE srl company (http://www.erreduegas.it/) to develop and commercialize device for hydrogen generation capable of supplying a maximum flow of 300 mL min⁻¹.

The hydrogen gas produced upon hydrolysis of aqueous solutions of NaBH₄ is extremely pure, devoid of carbon oxides and naturally humid, hence appropriate for its utilization in fuel cells with a polymeric electrolyte of the type known with the acronym PEMFC (Polymer Electrolyte Membrane Fuel Cell). It is generally agreed that the PEMFCs contain a solid electrolyte constituted by a polymeric cation-exchange membrane. There is no whatsoever restriction to use the hydrogen gas produced by aqueous NaBH₄ hydrolysis in fuel cells where the electrolyte is an anion-exchange membrane, known with the acronym AEFCs (Alkaline Electrolyte Fuel Cells), and the oxygen reduction at the cathode produces hydroxyl ions (OH⁻) that migrate to the anode instead oxide ions that remain at the anode to combine with the protons formed at the anode side as occurs in a PEMFC.

As one may realize reading what reported above, the state of the art in this field is rather wide and several solutions of devices for the generation of hydrogen have been achieved and described in the literature; it is, however, equally apparent that the known devices do not fully satisfy the market requirements, particularly as regards the production capacity of hydrogen, the stability of the catalysts with time, the operations of catalyst replacement, the cost of the catalyst, the possibility to interrupt the hydrogen evolution on demand, the possibility to use concentrated NaBH₄ solutions (up to 15 wt %) without compromising the catalytic system.

### SUMMARY OF THE INVENTION

In this invention is described a device containing a reactor capable of producing hydrogen gas by catalyzed hydrolysis of alkaline solutions of alkaline metal or alkaline-earth metal borohydrides.

### DESCRIPTION OF THE FIGURES

FIG. 1 (A-D) shows schematically three views, in horizontal and vertical sections (A, B and C), and a perspective view (D) of a reactor contained in the device of the invention.

FIG. 2 (A-D) shows schematically three views, in horizontal and vertical sections (A, B and D) and a perspective view (C) of a device according to the invention.

FIG. 3 shows a simplified scheme of an apparatus containing the device of the invention coupled to a fuel cell stack and to a battery.

FIG. 4 shows the hydrogen evolution with time in the experimental conditions of example 1.

FIG. 5 shows the hydrogen evolution with time in the experimental conditions of example 2.

FIG. 6 shows the power output with time supplied by a PEMFC stack (nominal power 100 W) fed with the hydrogen gas produced in the experimental conditions of example 1.

### DETAILED DESCRIPTION OF THE INVENTION

The present invention allows one to improve remarkably the performance of the known hydrogen generators thanks to a device containing a reactor for the production of hydrogen gas by catalyzed hydrolysis of aqueous alkaline solutions of alkaline or alkaline-earth metal borohydrides, preferably NaBH₄. Such a device allows one to improve the performance of the known hydrogen generators. In particular, one may notice the following improvements:
a) the hydrogen production capacity expressed as mL H₂ min⁻¹ g_{cat}⁻¹
b) the catalyst stability with time
c) the operations of catalyst substitution
d) the cost of the catalyst
e) the possibility to shut off the hydrogen production on demand
f) the possibility of using concentrated NaBH₄ solutions (up to 15 wt %) without damaging the catalytic system
g) an accurate control of the temperature of the NaBH4 hydrolysis, hence an accurate control of the hydrogen flow produced.

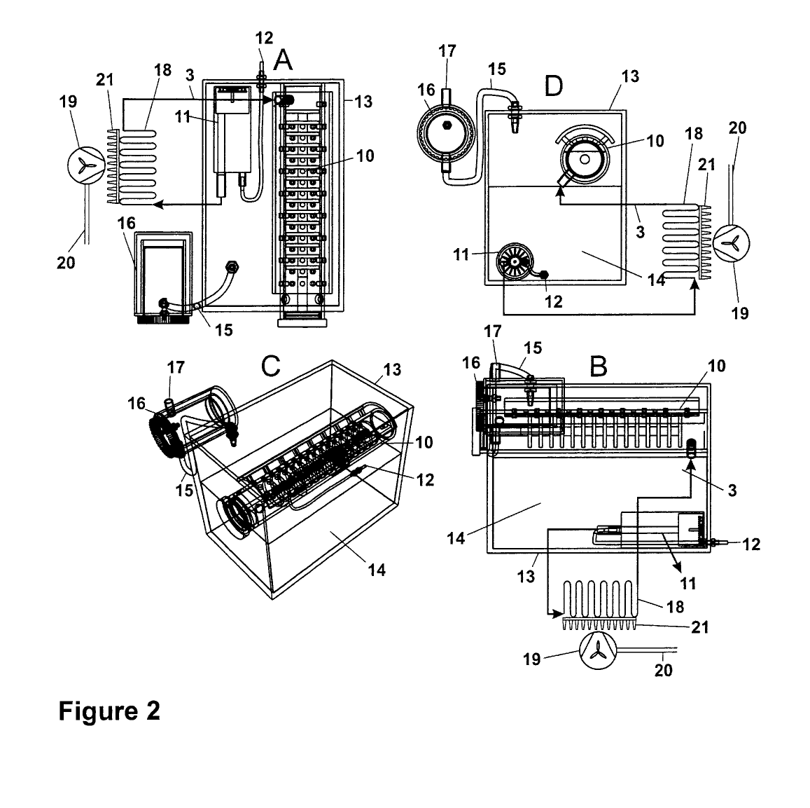

As illustrated in FIG. 2, the device of the invention is essentially constituted by a gastight container 13, a pump 11, a reactor 10. Externally to such a container 13 are then connected a drying device 16, equipped with an outlet hole 17, for the removal of the humidity from the gas produced, an heat exchanger 18 for an effective control of the hydrolysis temperature of the metal borohydride.

Any types of heat exchanger can be employed to control the internal temperature of the reactor when operating. For example, as heat exchanger, one may use a radiator with tubes made of a metal resistant to strong bases (stainless steel, copper), in contact with a heat dissipator 21 cooled by means of an axial or centrifugal fan 19 electronically controlled by a thermocouple or any other temperature sensor positioned inside the reactor. The immersion pump 11 is electrically fed with the insulated cable 12.

The improvements provided by the device of the invention are essentially due to the reactor where the hydrolysis of the NaBH₄—H₂O—NaOH system occurs catalyzed by finely dispersed ferromagnetic catalytic materials, preferably combined with transition metal borides, and in particular cobalt or nickel borides (CoₓB—Co; NiₓB—Ni where x=1, 2, 3; CoB—Ni, CoWB—Ni) (U. B. Demirci et al. Fuel Cells 2010, 10 (No. 3), 335).

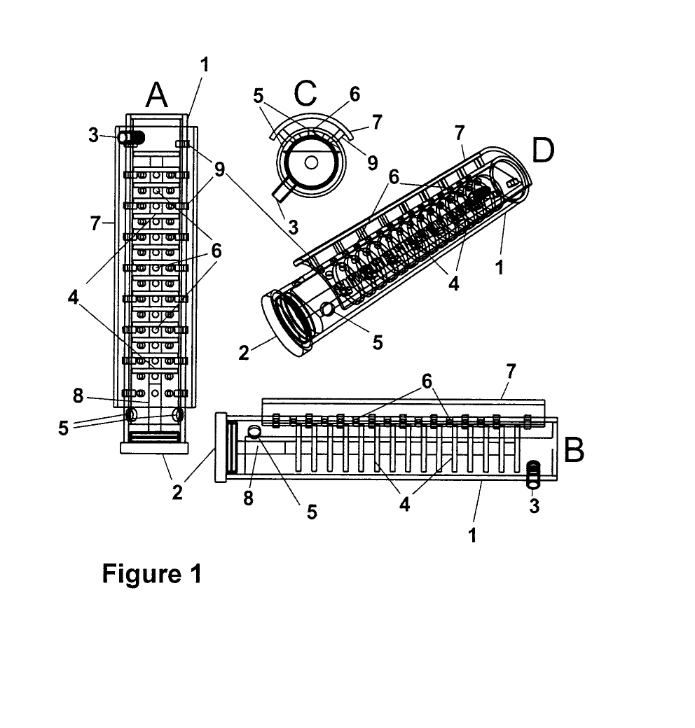

As illustrated in FIG. 1, the reactor of the invention is constituted by a hollow body, essentially cylindrical, closed at an end, while the other end is open and equipped with a cap 2. Said hollow body is inserted into the container 13 so as to lean out of the latter with its end closed by the cap 2. The reactor may be extractable (in this case suitable gaskets will ensure the gastight where the reactor gets out of the container) or integral with the container.

Inside the cylinder are disposed one or more permanent magnets 4 disposed on an extractable guide 8 which allows for the easy extraction of the magnets and their re-insertion.

In proximity to the sealed end of the cylinder is positioned the solution feeding pipe 3.

The upper surface of the cylinder contains the holes 6 that allow the hydrogen produced to come out; on the external surface of the cylinder and in correspondence to the holes 6 is positioned the aerosol abatement system 7, constituted by a layer of any material resistant to strong bases and fixed to the cylinder upper surface by suitable supports 9. Furthermore, the cylinder contains two holes 5, preferably positioned in proximity of one end of the cylinder 1, which allow the exhausted solution to come out.

Said permanent magnets may have any shape, for example circular or quadrangular with various thicknesses and will be covered by a material resistant to solutions of both strong acids and bases (for example NdFeB magnets coated with a Ni—Cu alloy).

The magnets may be positioned either parallel or orthogonal (or any their combination) to the flow of the metal borohydride solution, preferably parallel both to the reactor axis and to the liquid flow.

A desired amount of catalyst is anchored to the magnets. In view of the magnets disposition, the force lines of the magnetic field generated by the permanent magnets are parallel to the reactor axis as well as to the flow of the NaBH₄-strong base solution. The guide, and thus the magnets fixed to it, can be easily extracted through the opening sealed by cap 2 for the re-generation or substitution of the catalyst.

The pulling out of the magnet-holding guide can be made either mechanically or magnetically; in either case one may add more catalyst or a different catalyst. The catalyst can be removed from the catalytic block by the plain immersion into a diluted aqueous solution of any strong acids (HCl, H₂SO₄).

The catalyst loading on the magnet(s) surface is achieved by magnetic attraction and is easily realized by bringing the magnets close to the catalyst or rolling the cylindrical magnet-holding guide 8 on a plane covered by the catalyst.

In turn, the catalyst can be used in various forms and morphologies, preferably powders.

A huge variety of ferromagnetic catalysts can be effectively used in the reactor of the invention: cobalt or nickel powders, cobalt- or nickel Raney, alloyed Co—Ni Raney, cobalt or nickel nanoclusters, cobalt or nickel wires, nano- or micro-structured aggregates of nickel with nickel borides, nano- or micro-structured aggregates of cobalt with cobalt borides, mixed aggregates of cobalt and nickel with cobalt borides (U. B. Demirci et al. Fuel Cells 2010, 10 (No. 3), 3359). In the specific case of the reactor of the invention are preferably employed catalysts based on cobalt borides of the type Co—CoₓB (x=1, 2, 3) due to their high catalytic activity, the excellent resistance to strong bases and to chemical poisoning, the low activation temperature and the elevated resistance to passivation by NaBO₂ (H. B. Dai et al. J. Power Sources 2007, 177, 17; Wu et al. Mat. Letters 2005, 59, 1748; (U. B. Demirci et al. Fuel Cells 2010, 10 (No. 3), 335).

Nickel borides, cobalt-nickel borides or cobalt-nickel-tungsten borides (CoxB—Co; NixB—Ni where x=1, 2, 3; CoB—Ni, CoWB—Ni) can be equally and effectively used in the reactor of the invention. The catalytic system may also be constituted by one or more ferromagnetic metals, alone or combined with metal borides, noble and non-noble metals, preferably non-noble metals, in the form of threads, wires, plates or powders.

The powders may exhibit a granulometry varying between 10 nm and 50 microns, preferably from 1 to 50 microns, and the amount of catalyst anchored to the permanent magnets may vary from 10 mg to 5 g.

The device and all its components that come into contact with the basic solution of the metal borohydride will be apparently realized with strong-base resistant materials.

The operation of the device of the invention is extremely simple.

A flow of an aqueous NaBH₄-strong base solution is introduced into the reactor by means of the feeding pipe 3. Before entering the reactor, the NaBH₄-strong base solution is circulated inside a radiator 18, external to the tank 13, for an effective control of the hydrolysis temperature of the metal borohydride.

The NaBH₄-strong base solution flows along the reactor axis meeting the catalyst anchored to the magnets 4, hence hydrogen is produced according to reaction (1).

The hydrogen gas is discharged out of the reactor through the holes 6 and meets the aerosol abatement system 7 for a first separation of the gas from the solution and the recycling of the latter.

The partially exhausted solution comes out of the reactor from the holes 5 and is collected 14 in the container 13 to be recycled in the process; the exhausted solution is preferably kept below the reactor body, eventually providing to the necessary removal of the excess solution.

The aqueous solutions of the metal borohydrides are stabilized by adding strong bases such as such as LiOH, NaOH, KOH and CsOH, preferably NaOH.

In addition to NaBH₄, other metal borohydrides useful to the present invention are LiBH₄, NaBH₄. KBH₄, CsBH₄, Ca(BH₄)₂, Mg(BH₄)₂.

The solutions may contain a NaBH₄ concentration varying between 0.1 wt % and 50 wt %, preferably 15 wt %, and a concentration of NaOH varying between 0.1 wt % and 20 wt %, preferably from 2 wt % to 10 wt %.

Since the kinetics of reaction (1) are practically zero-order with respect to the NaBH₄ concentration in the presence of hydrolysis catalysts (Y. Kojima et al. Int. J. Hydrogen Energy 2002, 27, 1029; S.- C. Amendola et al. J. Power Sources 2000, 85, 186; A. Levy et al. Ind. Eng. Chem. 1960, 52, 211), the dilution of the solution dos not appreciably affect the rate of hydrogen generation until all NaBH₄ has been consumed.

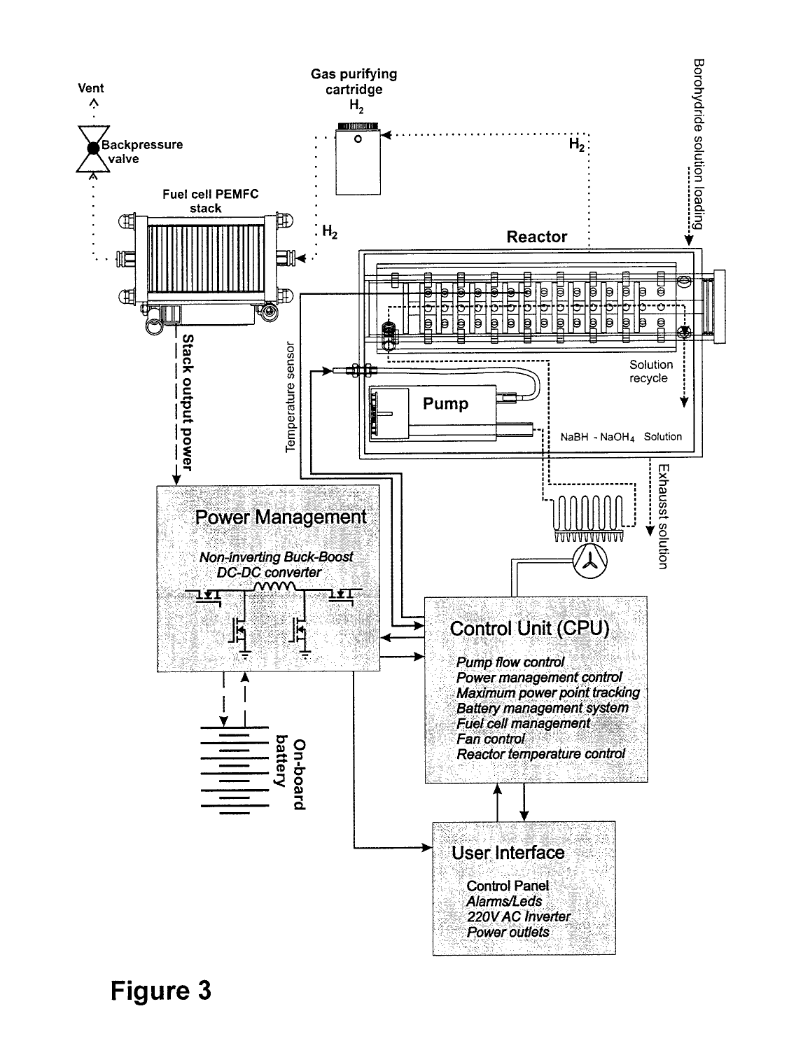

The hydrogen gas gets out through the manifold 15 and goes to the drying cartridge containing a material that is able to remove the humidity from the hydrogen (such as silica gel, molecular sieves, calcium chloride). Finally, the hydrogen gas is directed to the end user that may be a fuel cell stack (FIG. 3) or a combustion apparatus.

The hydrogen production is immediately stopped by switching off the pump 11 which completely drains the reactor.

An advantage of the device of the invention is just the possibility to interrupt the hydrogen production by switching off the centrifugal internal pump, thus causing the complete, passive draining of the reactor. In such a way, there is a constant control of the reactor activity and hydrogen can be generated on demand by the electronics of the system.

This advantage, together with the fact that the catalyst does not leach out of the reactor to contaminate the storage tank, ensure a high degree of operational safety even when the control electronics is malfunctioning or the pump fails.

A further advantage of the device of the invention is the presence of a temperature sensor inside the reactor that switches on-off the cooling fan (axial or centrifugal) 19 at the desired internal temperature of the reactor by means of an electronic control 20.

The exothermic reaction (1) takes place inside the reactor, hence in a room whose volume is largely smaller than that of the tank containing the NaBH₄—NaOH solution (FIG. 2).

This fact and the relatively long contact time between the NaBH₄—NaOH solution (the flow is actually controlled by the immersion pump) and the catalyst allows one to hydrolyze NaBH₄ at the desired temperature, preferably between 10 and 80° C., with consequent control of the intensity of the hydrogen flow as well as of the solubility of sodium metaborate, which is the hydrolysis product of NaBH₄.

This improves the efficiency of the catalytic systems as the precipitation of NaBO₂ may negatively affect the catalytic activity (U. B. Demirci et al. Fuel Cells 2010, 10 (No. 3), 335). One may therefore use high NaBH₄ concentrations, up to 15 wt % (W. Ye at al. J. Power Sources 2007, 164, 544; B. H. Liu et al. Thermochim. Acta 2008, 471, 103).

The internal volume of the reactor and of the device of the invention may be varied depending on whether the hydrogen generator (device) or the power generator are portable or stationary. The operational temperatures of the device may vary between −5° C. and 90° C., preferably between 0° C. and 60° C., and a device with a tank containing ca. 300 g of NaBH₄ may supply a constant flow of hydrogen of 3 L/min for ca. 4 h and a hydrogen flow of 1 L/min for ca. 12 h.

The differences, in terms of both construction technology and performance, between the reactor of the invention (FIG. 1) contained in the device and the system described in the patent EP 1496014A1 are clear to anybody skilled in the field. Some relevant differences are detailed below:
a) In the reactor of the present invention, the ferromagnetic catalyst is directly anchored to the permanent magnets. Such a solution allows for an improved anchoring of the catalyst inside the reactor, thus inhibiting the risk of leaching of the catalyst inside the feeding/discharging circuit of the device. Further on, such a solution allows for the recovery of the catalyst itself by the magnets close to the way out of the reactor, should the evolving hydrogen physically remove some catalyst.
b) The lines of force of the magnetic field inside the reactor of the invention are parallel to the reactor axis as well as to the NaBH₄-strong base solution flow.
c) Due to the reduced volume of the reactor of the invention and the long contact time between the NaBH₄—H₂O system and catalyst, the hydrolysis of NaBH₄ can occur at relatively high temperatures, up to 80° C., with high catalytic activity and no risk of sodium metaborate precipitation.
d) The use of either a radiator or a heat exchanger external to the storage tank of the NaBH₄—H₂O-strong base, equipped with a cooling fan controlled by a temperature sensor inside the reactor allows for an effective control of the temperature of the hydrolysis temperature, hence of the hydrogen flow produced. Due to the presence of the cooling system, one can also control the temperature of the tank inside which returns the partially exhausted solution after it has passed through the reactor.
e) Lower cost of the catalysts employable in the reactor of the invention as they are exclusively constituted by non-noble metals.
f) Higher hydrogen production rate, up to 3000 mL H₂ min⁻¹ g_{cat}⁻¹ as compared to the system described in Int. J. Hydrogen Energy 2008, 33, 51 with a Fe—Pt—Rh catalyst (426 mL H₂ min⁻¹ g_{cat}⁻¹).
g) Easier catalyst substitution.
h) Immediate shutdown of hydrogen production by switching off the immersion pump with no occurrence of passive phases as described in Int. J. Hydrogen Energy 2008, 33, 51.

As a further advantage, one has to consider that the device of the invention allows for the production of energy with an extremely favorable weight of the device/energy supplied ratio which allow a great flexibility of application and the use in various apparatus both fixed or mobile. For example, one may realize an apparatus (FIG. 3) with an overall operational weight lower than 10 Kg in which the hydrogen produced feeds a fuel cell stack with a nominal power of 300 W, eventually stored in a battery. Besides charging batteries, this apparatus may be also employed to power means of transport with electrical engines such as electrical bikes or marine engines.

As an alternative, the hydrogen produced by the device of the invention can be delivered to any end user such as an internal combustion engine or any other apparatus that requires hydrogen to operate.

In examples 1-3 is described the production of hydrogen gas with the device of the invention and, by comparison, the production obtainable with a static reactor in comparable experimental conditions.

In example 4 is described the production of electrical energy with a PEMFC stack (maximum nominal power 100 W) fed with the hydrogen produced in the experimental conditions of example 1.

### EXAMPLE 1

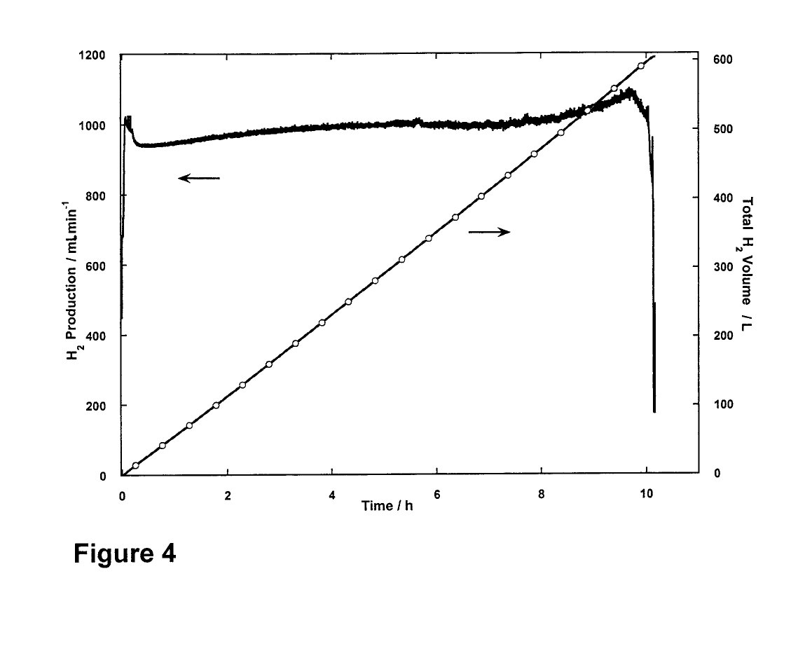

Into the storage tank 14 of a device of the invention (FIG. 2) are introduced 2 L of an aqueous solution containing NaBH₄ (4 M, 304 g) and NaOH (0.2 M, 16 g) which is pumped into the reactor by pump 11. The reactor contains 1 g of a Co—Co₂B catalyst, prepared as described in Phys. Chem. Chem. Phys. 2009, 11, 770, dispersed onto nine circular permanent magnets (NdFeB coated with Ni—Cu alloy) each of which with a diameter of 2.5 cm. The hydrogen gas produced is forced to go through a cartridge filled with molecular sieves to reduce the humidity of the gas before it enters a flow-meter (Bronkhorst High-Tec B. V.). The initial temperature of the NaBH₄—NaOH solution in the tank is ca. 25° C. Immediately after switching on the immersion pump (200 mL min⁻¹), the hydrolysis reaction (1) starts occurring in the reactor with the evolution of a hydrogen flow of ca. 500 mL min⁻¹. After 10 min, the device starts producing a hydrogen flow of ca. 900 mL min⁻¹ that stabilizes between 900 and 1000 mL min⁻¹ at an internal temperature between 34 and 38° C. This temperature interval is kept constant by means of the external cooling system. As shown in the diagram reported in FIG. 4, the hydrogen flow remains constant for more than 10 h, in agreement with a zero-order kinetics in NaBH₄ concentration of the catalyzed hydrolysis of NaBH₄ (Y. Kojima et al. Int. J. Hydrogen Energy 2002, 27, 1029; S.- C. Amendola et al. J. Power Sources 2000, 85, 186; A. Levy et al. Ind. Eng. Chem. 1960, 52, 211) as well as an overall conversion of the NaBH₄—H₂O system into H₂ equal to 84%.

Once removed the exhausted solution (selective formation of NaBO₂ as shown by an ¹¹B{¹H} NMR analysis), a new identical solution of NaBH₄—H₂O—NaOH is introduced into the storage tank and the immersion pump is again switched on. Almost immediately, a flow of hydrogen gas of 960 mL min⁻¹ is measured. Identical results are obtained repeating the experiment four times without changing the catalyst.

### EXAMPLE 2

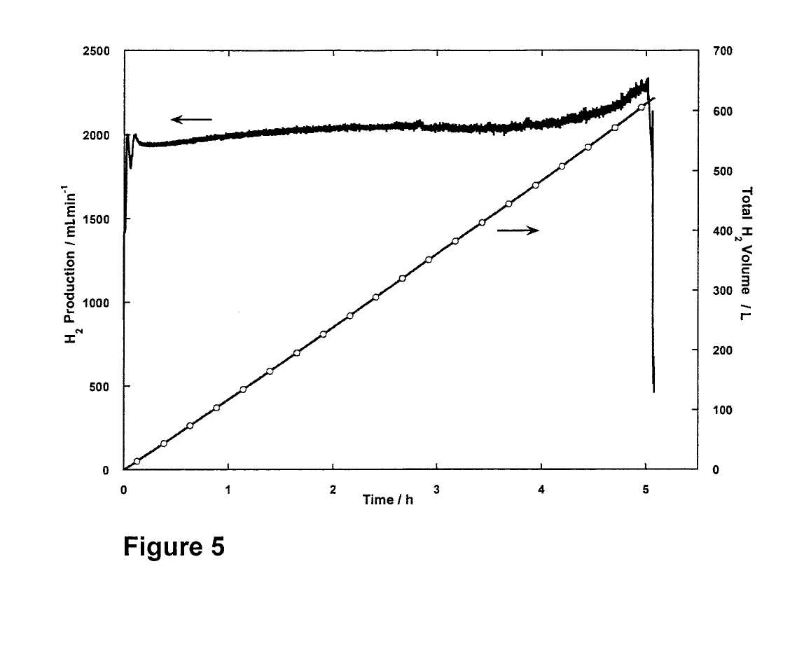

Into the storage tank 14 of a device of the invention (FIG. 2) are introduced 2 L of an aqueous solution containing NaBH₄ (4 M, 304 g) and NaOH (0.2 M, 16 g) which is pumped into the reactor by pump 11. The reactor contains 2 g of a Co—Co₂B catalyst, prepared as described in Phys. Chem. Chem. Phys. 2009, 11, 770, dispersed onto nine circular permanent magnets (NdFeB coated with Ni—Cu alloy) with a diameter of 2.5 cm. The hydrogen gas produced is forced to go through a cartridge filled with molecular sieves to reduce the humidity of the gas before it enters a flow-meter (Bronkhorst High-Tec B. V.). The temperature of the NaBH₄—NaOH solution in the tank is ca. 25° C. Immediately after switching on the immersion pump (200 mL min⁻¹), the hydrolysis reaction (1) starts occurring in the reactor with the evolution of a hydrogen flow of ca. 900 mL min⁻¹. After 10 min, the device starts producing a hydrogen flow between 1800 and 1900 mL min⁻¹ at an internal temperature between 36 and 38° C. This temperature interval is kept constant by means of the cooling system. AS shown in the diagram reported in FIG. 5, the hydrogen flow remains constant for more than 5 h, in agreement with a zero-order kinetics of the catalyzed hydrolysis of NaBH₄ (Y. Kojima et al. Int. J. Hydrogen Energy 2002, 27, 1029; S.- C. Amendola et al. J. Power Sources 2000, 85, 186; A. Levy et al. Ind. Eng. Chem. 1960, 52, 211) as well as an overall conversion of the NaBH₄—H₂O system into H₂ equal to 86%.

Once removed the exhausted solution (selective formation of NaBO₂ as shown by an ¹¹B{¹H} NMR analysis), a new identical solution of NaBH₄—H₂O—NaOH is introduced into the storage tank and the immersion pump is again switched on. After 3 min, a flow of hydrogen gas of 1900 mL min-1 is measured. Identical results are obtained repeating the experiment four times without changing the catalyst.

### EXAMPLE 3 (COMPARATIVE EXAMPLE)

Into a two-necked 3 L vessel, one outlet being connected to a gas flow-meter, is introduced 1 g of a Co—Co₂B catalyst, prepared as described in Phys. Chem. Chem. Phys. 2009, 11, 770, dispersed onto nine circular permanent magnets (NdFeB coated with Ni—Cu alloy) each of which with a diameter of 2.5 cm. Next are introduced two liters of an aqueous solution containing NaBH₄ (4 M, 304 g) and NaOH (0.2 M, 16 g). The initial temperature of the solution inside the tank is ca. 25° C. Hydrogen is immediately evolved and is forced to pass through a cartridge filled with molecular sieves before entering the flow-meter (Bronkhorst High-Tec B. V.). The initial hydrogen flow is ca. 550 mL min⁻¹ and after 15 min it increases to more than 10 L min⁻¹ while the temperature of the solution reaches gradually the boiling point. The hydrogen flow decreases rapidly until it comes to an end after 50 min. The overall conversion of the NaBH₄—H₂O system into H₂ is equal to 78%.

### EXAMPLE 4

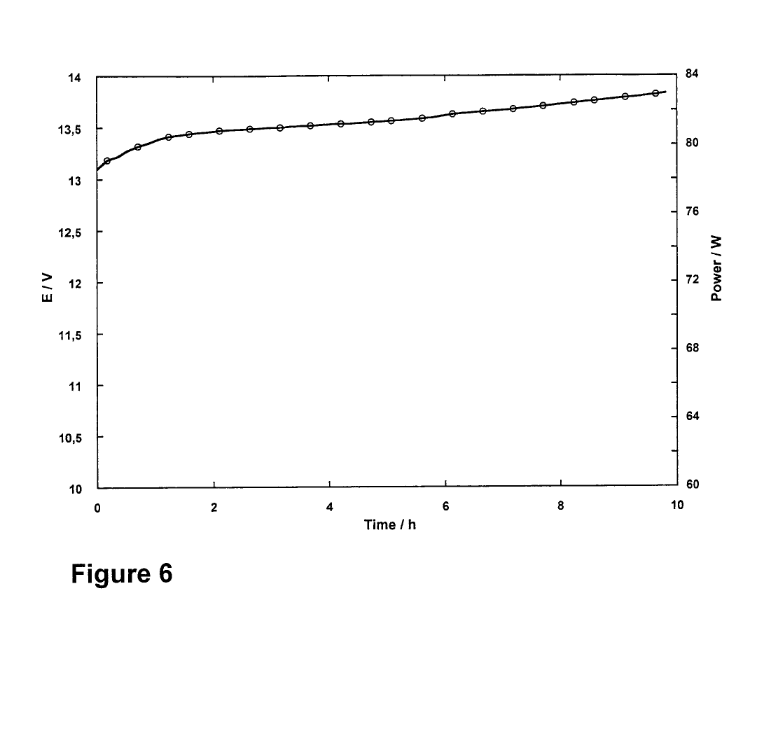

A commercial PEMFC stack with self-breathing cathodes is fed with the hydrogen produced in the experimental conditions of example 1 (900-1000 mL min⁻¹). The stack performance is evaluated by means of a Scribner Associates 850e (USA) instrument. FIG. 6 shows a galvanostatic diagram for a 6 A current.

1.-9. (canceled)

10. Device comprising: a gastight tank (13), a pump (11), a heat-exchanger (18-21) and a reactor (10) for the production of hydrogen gas by catalyzed hydrolysis of aqueous alkaline solutions of alkaline metal or alkaline-earth metal borohydrides wherein said reactor (10) is constituted by a hollow body, essentially cylindrical in shape, (1) sealed at an end while the opposite end is open and equipped with a cap (2) where said cylinder contains holes (5) for the discharge of the exhausted solution and contains one or more permanent magnets (4) coated by ferromagnetic catalysts directly anchored to said permanent magnets held by an extractable guide (8) which allows their easy extraction and insertion into the cylinder characterized in that it comprises a temperature sensor and in that said reactor (10), pump (11) and temperature sensor are inserted into the tank (13).

11. Device according to claim 10 where said ferromagnetic catalysts are selected from the group consisting of cobalt or nickel powders, cobalt- or nickel Raney, alloyed Co—Ni Raney, cobalt or nickel nanoclusters, cobalt or nickel wires, nano- or micro-structured aggregates of nickel with nickel borides, nano- or micro-structured aggregates of cobalt with cobalt borides, and mixed aggregates of cobalt and nickel with cobalt borides.

12. Device according to claim 10 wherein the hydrogen produced by catalyzed hydrolysis of aqueous alkaline solutions of alkaline metal or alkaline earth-metal borohydrides leaks from the reactor through holes (6) and meets an aerosol abatement system (7) for a first separation of the gas from the solution and the recovery of the latter.
